(19) United States
(12) Patent Application Publication
(10) Pub. No.: US 2003/0025943 A1
(43) Pub. Date: Feb. 6, 2003

(54) E-mail based inquiry-response automation

(76) Inventor: Dawn Carey, Encino, CA (US)

Correspondence Address: NETZERO INC., 2555 TOWNSGATE RD., WESTLAKE VILLAGE, CA, 91361, US

(21) Appl. No.: 09/920,481

(22) Filed: Aug. 1, 2001

(51) Int. Cl. B41J 1/00; G06F 15/00; H04N 1/00

(52) U.S. Cl. 358/402; 358/1.15

(57) ABSTRACT

In accordance with the present invention, an automated inquiry-response e-mail based content delivery system is provided for delivering items of content to client devices at remote locations. Further provided are methods of delivering items of content from a storage location to client devices at remote locations through e-mail based inquiry-response automation.

### BACKGROUND OF THE INVENTION

1. Field of the Invention

The present invention relates to information distribution. More particularly the invention relates to automatically responding via e-mail to inquiries received via e-mail.

2. Description of Related Art

Recent improvements in information transferring technology have created a wide variety of mechanisms capable of immediately transferring information between remote locations. Accordingly, it is desirable to utilize such technologies to provide customers, potential customers, clients or other interested parties with virtually immediate access to information in a readily usable form. The information itself may take any form including technical support, advertisements, data sheets, notices, etc.

In the past, telephone operators and support staff have typically been required to receive the information requests. The requested advertisement or other information is then manually placed in an envelope and mailed to the requesting party, or manually faxed or e-mailed to the customer. Unfortunately such a process relies on manual labor and the customer often does not receive the desired information for several days. In operations which receive a large volume of information requests, the labor costs can be relatively high. In smaller volume operations, valuable worker time is spent doing these relatively simple yet critical tasks. Therefore, there is a need for an automated information delivery system which can rapidly transfer desired information to a requesting party, without requiring the attention of the sending party's staff.

A number of low-cost information dissemination methods have been used. These include interactive inquiry-response systems, FAQs (lists of frequently asked questions and their answers), and e-mail based technical support. Each of these methods have suffered drawbacks, such as high cost, difficulty to set up or maintain, scalability, customizability, accountability, dependability, predictability, and many other drawbacks. Therefore, there is a need for an automated inquiry-response system which is low in cost to set up and maintain, easy to maintain, scalable, customizable, accountable, dependable and predictable.

### SUMMARY OF THE INVENTION

In accordance with one aspect of the invention, there is a method of delivering items content from a storage location to client devices at remote locations through e-mail based inquiry-response automation. In the method, the items of content are stored, and there are also stored respective descriptions of the items of content and respective order codes for the items of content.

In an inquiry-response transaction phase of the method, a first message is received via e-mail from a user of a given client device at a remote location. Next, a prompt message is sent via e-mail in response to the first e-mail message. The prompt e-mail message includes an arrangement of descriptions and order codes for a plurality of the items of content, and instructions to the user for ordering the items of content.

If a second message is received via e-mail from the user, then the second e-mail message is parsed for at least one of the order codes specified by the user. The items of content identified by the order codes in the second e-mail message are then extracted and packaged into a single package unit.

Then, a response e-mail message is sent which comprises the single package unit comprising the items of content corresponding to the order codes in the second e-mail message.

In accordance with another aspect of the present invention, an automated inquiry-response response e-mail based content delivery system is provided for delivering items of content to client devices at remote locations.

Numerous variations on these methods and systems are within the scope of the invention.

### DESCRIPTION OF THE DRAWINGS

The present invention will be described by way of exemplary embodiments, but not limitations, illustrated in the accompanying drawings in which like references denote similar elements.

FIG. 1 is a block diagram of a system having a content delivery system in accordance with the invention.

FIG. 2 is a flowchart of method of delivering content from a storage location to client devices at remote locations through e-mail based inquiry-response automation in accordance with the invention.

FIG. 3 is a flowchart of a method of interposing human intervention into an automated e-mailed inquiry-response content delivery process.

### DETAILED DESCRIPTION OF THE INVENTION

Throughout this description, the embodiments and examples shown should be considered as exemplars, rather than limitations on the apparatus and methods of the present invention.

The System of the Invention

The present invention provides an automated inquiry-response e-mail based content distribution system which allows users to request the delivery of content (electronic material, such as document files, graphics files, sound files, video files, web pages, multimedia files, executable programs and utilities) from a remote content repository and to have that content delivered to the user in short order via e-mail. An item of content is anything which may be delivered in an e-mail message. The items of content may contain technical support information, advertisements, notices, product data sheets, photographs, artwork, works of music, video programs, movies, games, computer programs, etc.

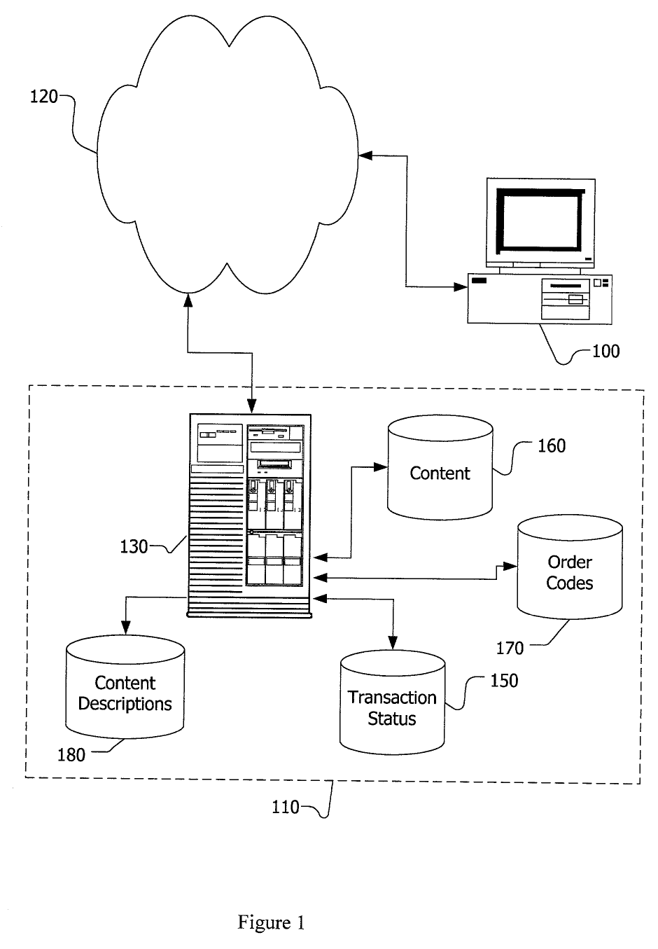

The system of the invention may be embodied using commonly available general purpose computer devices utilizing a combination of commonly available and special-purpose computer software. Referring now to FIG. 1, there is shown a block diagram of a system in accordance with one aspect of the invention. FIG. 1 includes a client device 100, an automated inquiry-response e-mail based content delivery system 110 and a network 120. The automated inquiry-response e-mail based content delivery system 110 includes a server 130 and plural databases 150, 160, 170, 180.

The client device 100 preferably comprises a client computer that is configured to send e-mail messages to and receive e-mail messages from the network 120. The client device 100 may be, for example, a PC running a Microsoft Windows operating system and an e-mail client such as Microsoft Outlook, Qualcomm Eudora, or Netscape Communicator. The client device 100 may also be, for example, a network appliance, personal digital assistant (PDA), mobile phone, refrigerator or another server.

The user of the client device 100 may have a formal or informal relationship with the operator of the content delivery system 110. Where the user is a member of an on-line service (e.g., Internet service, BBS, private interactive service), the user typically provides some form of identification as part of a log on process. This identification may be a user ID/password, electronic signature, biometric signature, the user's profile, etc. In some cases, the user's use of the client device 100 creates a presumption of user identity, such as in the case of a mobile phone or PDA. In these cases, the service provider may operate the content delivery system 110, such as for providing customer support. In other cases, a user may have only a passive affiliation with the operator of the content delivery system 110.

The network 120 provides lower layer network support for the client device 100 to interact with other devices on the network, including the server 130. The network 120 may be, for example, a common or private bidirectional telecommunications network (e.g., a public switched telephone network (PSTN), a cable-based telecommunication network, a LAN, a WAN, a wireless network), coupled with or overlaid by a TCP/IP network (e.g., the Internet or an intranet), or combinations thereof.

The server 130 is one or more computer programs which as a group provide the indicated services. This software may operate on one computer, or may be operated on a number of computers or other devices. The computers may be general purpose devices, or may have some specialization.

The databases include a transaction status database 150, a content repository 160, a database for content order codes 170, and a database of content descriptions 180. The transaction status database 150 stores data relating to the inquiry-response content delivery transactions involving the server 130. This data may include a tracking code assigned to each transaction, and status codes signifying varying states of the transactions.

The content repository 160 stores items of content and/or the address of items of content (e.g., URL or network address) which may be distributed to the client device 100. In some circumstances it may be preferable to distribute the items of content; in other circumstances it may be preferable to distribute the address of the items of content, for example as hyperlinks. From a technical standpoint, there is little difference to distributing an item of content and an address of an item of content. Hence, references to and discussions of items of content should be understood to incorporate like references to and discussions of address of items of content.

The database for content order codes 170 stores a code associated with each item of content in or identified in the content repository 160. The content order codes are used by the users to identify which items of content they wish to receive. In some embodiments, it may be desirable to provide the users with descriptions of the content, the title of items of content, and other information about the content. This information may be stored in the content description database 180.

One embodiment of the system 110 is for providing technical support information to users. In such an embodiment, it is preferable to provide requested text documents directly to the users. Furthermore, the descriptions of the items of content would comprise a list of technical support topics, such as the most commonly asked technical support questions, with the order codes being used to retrieve the technical support documents associated with the respective topics.

Computer and communications technology does not generally limit the location of components such as the server 130 and the databases 150, 160, 170, 180. The server 130 and the databases 150, 160, 170, 180 may be physically adjacent or even combined in a single physical device or structure, and may themselves be dispersed and distributed.

The Methods of the Invention

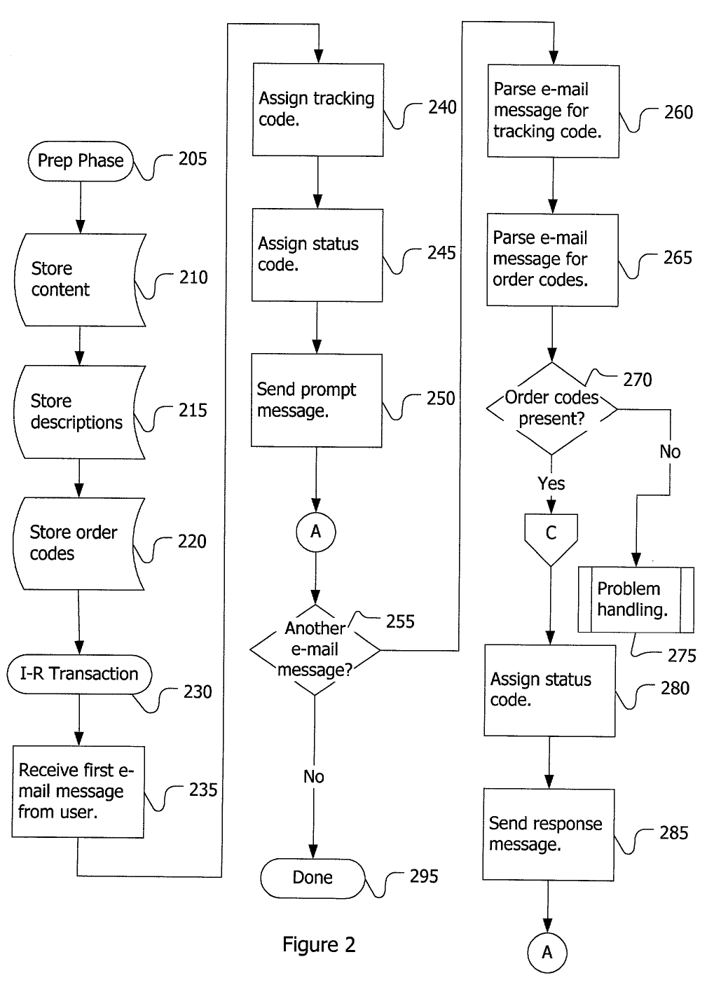

Referring now to FIG. 2, there is shown a flowchart of method of delivering content from a storage location to client devices at remote locations through e-mail based inquiry-response automation in accordance with the invention. The method comprises two phases—a preparation phase and an inquiry-response transaction phase.

The preparation phase (step 205) comprises setting up the databases 150, 160, 170, 180. In a first step, plural items of content are stored in the content repository 160. The descriptions of the items of content may be stored in the description database 180 (step 215). The respective order codes for the items of content may be stored in the order code database 170 along with the addresses of the items of content (step 220).

In the inquiry-response transaction phase, the user and the server communicate via e-mail to deliver items of content desired by the user to the user.

The inquiry-response phase (step 230) begins when the server 130 receives a first message via e-mail from a user of a given client device (step 235). Ostensibly, the e-mail address on the server 130 will be published or otherwise made available to the user. A routing scheme may also be used to direct the first e-mail message to the server 130. The first e-mail message may include any content or no content at all.

The server 130 then may assign a tracking code for the inquiry-response transaction initiated by the receipt of the first e-mail message (step 240). The server 130 may store the first e-mail message, and may associate the tracking code with the stored first e-mail message.

In those embodiments where it is desirable to track the status of transactions, status codes may be associated with the tracking code and/or the first e-mail message. For example, after receiving the first e-mail message (step 230), the server may assign a status code which indicates receipt of an initial e-mail message from a user.

The server then automatically replies to the first e-mail message with its own e-mail e-mail—referred to herein as a prompt e-mail message (step 250). The prompt e-mail message includes an arrangement (e.g., list or table) of descriptions and order codes for a plurality of the items of content. The prompt e-mail message also includes instructions to the user for ordering the items of content, and may include information about how the system 110 operates and what it is. The prompt e-mail message may include the tracking code. The tracking code may be placed in the subject (i.e., “Re:”) portion of the prompt message.

The specific information in the prompt e-mail message may be selected based upon the identity of the user. For example, if the user is of a specific class of users (e.g., free Internet access patrons vs. paying Internet access patrons, and adults vs. minors), then the items of content offered, the descriptions and/or order codes may be tailored to the class. Such customization may also be done based upon the domain of the user's e-mail address. Consider too that if the automated inquiry-response content delivery system 110 has multiple e-mail addresses, the automated inquiry-response content delivery system may be programmed to respond differently to incoming e-mail messages depending on which e-mail account is the recipient.

When the user receives the prompt e-mail message, the user may then either reply or not reply (step 255). If the user does not reply, then the process is complete (step 295). However, in most cases the user will read the instructions in the prompt e-mail message, review the descriptions of the content, and reply with a selection of one or more content codes.

After the server 130 receives a second e-mail message from the user (step 255), the server parses the second e-mail message and identifies the tracking code in the second e-mail message (step 260). If the user used the “reply” function available in most e-mail client software, the second e-mail message will automatically include the tracking code. Thus, server 130 can detect that the second e-mail message is associated with the first e-mail message. The server 130 may also store the second e-mail message, and may associate the tracking code with the stored second e-mail message. If there is no tracking code in the second-email message, the second e-mail message can be treated like the first e-mail message, with processing continuing at step 240, or processing may continue at step 265.

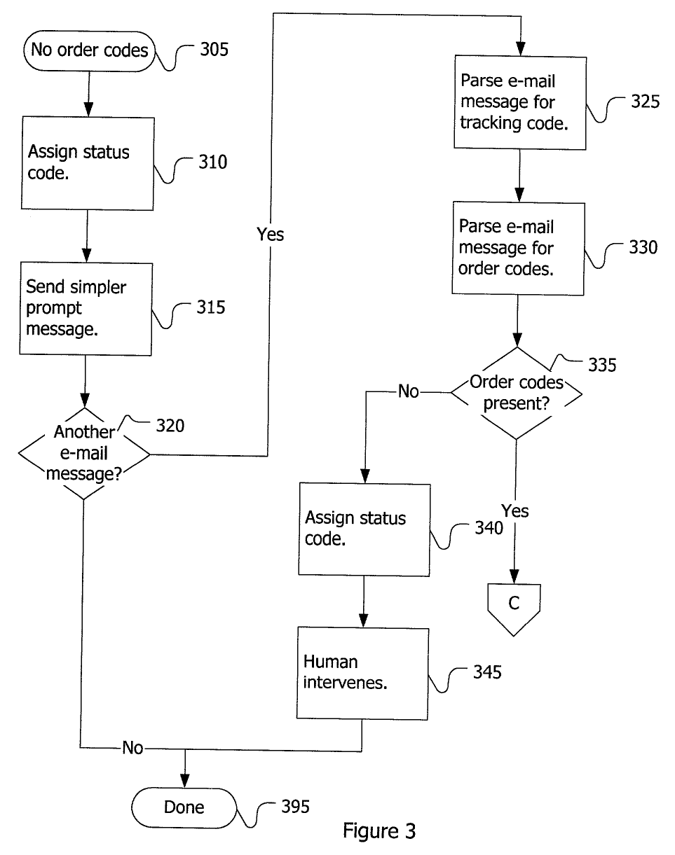

Next, the server 130 parses the second e-mail message for at least one of the order codes (step 265). The parsing algorithm of the server 130 differentiates between order codes specified by the user and order codes which are present because the second e-mail message is a reply to the prompt e-mail message (which had the list of order codes). In some cases, the user does not understand the instructions in the prompt e-mail message, or does not understand that the prompt e-mail message was from an automated system. In such cases, the second e-mail message will have no order codes and the transaction is subject to problem handling (step 275), which is discussed below with reference to FIG. 3.

If the second e-mail message includes at least one order code, a second status code may be assigned to the transaction (step 280). This status code may indicate receipt of the order, and may also may indicate the items of content requested. It may at this point be desirable to determine whether delivering items of content to the user or the user's client device is permitted, and/or if delivering the items of content indicated by those order codes is permitted. Although the order codes included in the prompt message may be limited, it may be desirable to determine if the user has selected order codes which were not in the prompt message, and possibly to block from the user the corresponding items of content.

The server 130 next responds via e-mail to the second e-mail message with a response e-mail message (step 285). The response e-mail message comprises the items of content (or addresses of the items of content, as the case may be) corresponding to the order codes in the second e-mail message. In this step, the server 130 gathers the items of content from the content repository 160 and compiles them into the single response e-mail message. The response e-mail message may include notations or other delineations between items of content to ease readability to the user, to show that each item of content requested by the user is present, or for other reasons. Providing the user with the ability to request multiple items of content via a single request is central to the user experience, as is the system's ability to combine the requested items of content into a single e-mail response message. Subsequently, the process can continue at step 255, with the user requesting more items of content and the server responding with the requested items of content, until the user requests no more (step 295).

Where additional tracking is desired, status codes may be stored at other points in the transactions. After responding with the prompt message (step 250), a status codes may be assigned to indicate that the prompt e-mail message has been sent. After responding with the response e-mail message (step 285), a status codes may be assigned to indicate that the response e-mail message has been sent.

In some embodiments, it may be undesirable to include tracking codes in the prompt e-mail message. In such embodiments, the second e-mail message may be parsed to determine if the second e-mail message forms a thread with the first e-mail message and the prompt e-mail message. This may be done by tracking when the first e-mail message was received, when the prompt e-mail message was sent, and making a reasonable deduction if the second e-mail message was received within a certain period of time and included order codes.

As mentioned above, the automated inquiry-response e-mail based content delivery system of the invention may be used for delivery of such content as music, videos and executable programs. It is common to charge users for receipt of these kinds of content, and the automated inquiry-response e-mail based content delivery system 110 may include software for attending to the necessary accounting. In this regard, prices may be associated with the order codes, and there may be accounts for the users which are charged when the system 110 e-mails the desired content.

Limits may be placed upon the number or quantity of items of content which a given user can receive, or can receive in a given period.

FIG. 3 is a flowchart of a method of interposing human intervention into an automated e-mailed inquiry-response content delivery process. In some embodiments of the automated e-mail inquiry-response system of the invention, it may be desirable to have a human intervene in the transaction. The method of FIG. 3 highlights one possible reason the user is not able or refuses to follow the instructions in the prompt e-mail message.

If the second e-mail message does not include any order codes or if the second e-mail message has questionable order code selections (step 305), then the server 130 may assign a status code to show that the error condition (step 310). Before having a human intervene, it may be more cost-effective to have the automated system 110 continue to try to complete the transaction with the user. Thus, in step 315, the server 130 sends a simpler prompt e-mail message to the user, or one that asks for clarification of the user's selections, as the case may be. This simpler prompt e-mail message may be shorter, have simpler language, and/or may explain the operation of the inquiry-response interaction better. Because some may users may not have recognized that the prompt e-mail message is generated automatically, the simpler prompt e-mail message may make this explicit.

If the user does not respond to the simpler prompt e-mail message (step 320), then the transaction is complete (step 395). Otherwise, as in steps 260 etc., the server 130 receives a third e-mail message from the user and parses the e-mail message for the tracking code (step 325).

Next, the server 130 parses the third e-mail message for at least one of the order codes (step 330). If the third e-mail message includes at least one order code (step 335), then the transaction may be handled as a normal transaction, with the flow continuing at step 280 in FIG. 2.

However, if the third e-mail message does not include at least one order code (step 335), then the server 130 assigns a status code to indicate this (step 340), and seeks human intervention in the transaction (step 345). The server 130 may involve a human by forwarding the third e-mail message or through other customer resource management techniques known in the art. The human may then complete the transaction, or may resolve issues and re-introduce the transaction into the automated inquiry-response system 110.

This automated system 100 may be operated 24 hours a day, 7 days a week, and the system 110 can reply to e-mail messages from the users in minutes or less. Through multiprocessing techniques, an automated inquiry-response content delivery system in accordance with the invention can process numerous incoming e-mail messages, and generate and transmit numerous outgoing e-mail messages simultaneously. The system and method of the invention can scale from small operations to very large operations. In one embodiment of the invention for providing technical support to the users of an Internet access service, it was found that about 80% of the 29-33,000 e-mail messages from users seeking technical support could be handled by the automated inquiry-response system.

Revisions are simply a matter of revising the prompt e-mail message, and ensuring that the necessary content and order codes have been stored. A single person with little technical training can make these kinds of changes, and can do so as frequently as desired. Because of its simplicity, the system of the invention is easily embodied, entail a modest cost, and scales with the scalability of the underlying e-mail system.

Although exemplary embodiments of the present invention have been shown and described, it will be apparent to those having ordinary skill in the art that a number of changes, modifications, or alterations to the invention as described herein may be made, none of which depart from the spirit of the present invention. In one modification, the e-mail messages form the user are stored at different times than that specified above. In another modification, the user's e-mail messages are not stored at all. In another modification, varying levels of customization, prioritization, and security may be applied depending on the identity of the user, the items of content requested, the e-mail address of the automated inquiry-response content delivery system, or other factors. All such changes, modifications and alterations should therefore be seen as within the scope of the present invention.

It is claimed:

1. A method of delivering items of content from a storage location to client devices at remote locations through e-mail based inquiry-response automation, the method comprising the steps of
storing plural items of content
storing respective descriptions of the items of content and respective order codes for the items of content
receiving a first message via e-mail from a user of a given client device at a remote location, whereby an inquiry-response transaction is initiated
assigning a tracking code for the inquiry-response transaction
responding via e-mail to the first e-mail message with a prompt message, the prompt e-mail message including an arrangement of descriptions and order codes for a plurality of the items of content, the tracking code, and instructions to the user for ordering the items of content
receiving a second message via e-mail from the user
parsing the second e-mail message and identifying the tracking code in the second e-mail message
parsing the second e-mail message for at least one of the order codes specified by the user
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

2. The method of delivering items of content from a storage location to client devices at remote locations through e-mail based inquiry-response automation of claim 1, further comprising, after the step of parsing the second e-mail message for at least one of the order codes, if the second e-mail message does not have at least one order code specified by the user, then responding via e-mail to the second e-mail message with a simpler prompt message, the simpler prompt e-mail message including the arrangement of descriptions and order codes for a plurality of the items of content, the tracking code, and simpler instructions to the user for ordering the items of content.

3. The method of delivering items of content from a storage location to client devices at remote locations through e-mail based inquiry-response automation of claim 2, further comprising
receiving a third message via e-mail from the user
parsing the third e-mail message and identifying the tracking code in the third e-mail message
parsing the third e-mail message for at least one of the order codes specified by the user
if the third e-mail message does not have at least one order code specified by the user, then referring the third e-mail message to a human specialist at a client device
if the third e-mail message has at least one order code specified by the user, then
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

4. The method of delivering items of content from a storage location to client devices at remote locations through e-mail based inquiry-response automation of claim 1, wherein the response e-mail message includes the tracking code.

5. The method of delivering items of content from a storage location to client devices at remote locations through e-mail based inquiry-response automation of claim 1, the step of receiving the first e-mail message further comprising storing the first e-mail message.

6. The method of delivering items of content from a storage location to client devices at remote locations through e-mail based inquiry-response automation of claim 1, the step of receiving the second e-mail message further comprising storing the second e-mail message.

7. The method of delivering items of content from a storage location to client devices at remote locations through e-mail based inquiry-response automation of claim 1, wherein
the items of content comprise technical support documents
the descriptions of the items of content comprise common technical support questions which are answered by the respective technical support documents.

8. The method of delivering items of content from a storage location to client devices at remote locations through e-mail based inquiry-response automation of claim 1, the method further comprising
after receiving the first e-mail message, assigning a first one of plural status codes signifying varying states of e-mail based inquiry-response transactions, the first status code to indicative that the first e-mail message has been received
after receiving the second e-mail message, assigning a second one of the status codes to the inquiry-response transaction to thereby indicate that the second e-mail message has been received.

9. The method of delivering items of content from a storage location to client devices at remote locations through e-mail based inquiry-response automation of claim 8, the method further comprising
after responding with the prompt message, assigning a third one of the status codes to the inquiry-response transaction to thereby indicate that the prompt e-mail message has been sent
after responding with the response e-mail message, assigning a fourth one of the status codes to the inquiry-response transaction to thereby indicate that the response e-mail message has been sent.

10. The method of delivering items of content from a storage location to client devices at remote locations through e-mail based inquiry-response automation of claim 1, the method further comprising restricting and restraining access by the users to the items of content in accordance with specified criteria.

11. The method of delivering items of content from a storage location to client devices at remote locations through e-mail based inquiry-response automation of claim 10, the restricting step including determining whether delivering items of content to the given user's client device is permitted, wherein if delivering information to the given user's client device is not permitted, then the selected items of content will not be delivered.

12. The method of delivering items of content from a storage location to client devices at remote locations through e-mail based inquiry-response automation of claim 10, the restricting step including determining whether delivering items of content to the given user is permitted, wherein if delivering information to the given use is not permitted, then the selected items of content will not be delivered.

13. An automated inquiry-response e-mail based content delivery system for delivering items of content from a repository to client devices at remote locations, the automated inquiry-response e-mail based content delivery system comprising
a first database storing respective descriptions of the items of content
a second database storing respective order codes for the items of content
means for receiving a first message via e-mail from a user of a given client device at a remote location, whereby an inquiry-response transaction is initiated
means for assigning a tracking code for the inquiry-response transaction
means for responding via e-mail to the first e-mail message with a prompt message, the prompt e-mail message including an arrangement of descriptions and order codes for a plurality of the items of content, the tracking code, and instructions to the user for ordering the items of content
means for receiving a second message via e-mail from the user
means for parsing the second e-mail message and identifying the tracking code in the second e-mail message
means for parsing the second e-mail message for at least one of the order codes specified by the user
means for extracting the items of content identified by the order codes in the second e-mail message
means for packaging the items of content from the extracting step into a single package unit
means for responding via e-mail to the second e-mail message with a response e-mail message comprising the single package unit comprising the items of content corresponding to the order codes in the second e-mail message.

14. The automated inquiry-response e-mail based content delivery system for delivering items of content from a repository to client devices at remote locations of claim 13, further comprising means for detecting if the second e-mail message has at least one order code specified by the user, and if not then responding via e-mail to the second e-mail message with a simpler prompt message, the simpler prompt e-mail message including the arrangement of descriptions and order codes for a plurality of the items of content, the tracking code, and simpler instructions to the user for ordering the items of content.

15. The automated inquiry-response e-mail based content delivery system for delivering items of content from a repository to client devices at remote locations of claim 14, further comprising
means for receiving a third message via e-mail from the user
means for parsing the third e-mail message and identifying the tracking code in the third e-mail message
means for parsing the third e-mail message for at least one of the order codes specified by the user
means for detecting if the third e-mail message has at least one order code specified by the user, and if not then referring the third e-mail message to a human specialist at a client device
means for detecting if the third e-mail message has at least one order code specified by the user, and if so then
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

16. The automated inquiry-response e-mail based content delivery system for delivering items of content from a repository to client devices at remote locations of claim 13, wherein the response e-mail message includes the tracking code.

17. The automated inquiry-response e-mail based content delivery system for delivering items of content from a repository to client devices at remote locations of claim 13, the means for receiving the first e-mail message further comprising means for storing the first e-mail message.

18. The automated inquiry-response e-mail based content delivery system for delivering items of content from a repository to client devices at remote locations of claim 13, the means for receiving the second e-mail message further comprising means for storing the second e-mail message.

19. The automated inquiry-response e-mail based content delivery system for delivering items of content from a repository to client devices at remote locations of claim 13, wherein
the items of content comprise technical support documents
the descriptions of the items of content comprise common technical support questions which are answered by the respective technical support documents.

20. The automated inquiry-response e-mail based content delivery system for delivering items of content from a repository to client devices at remote locations of claim 13, the method further comprising
means for, after receiving the first e-mail message, assigning a first one of plural status codes signifying varying states of e-mail based inquiry-response transactions, the first status code to indicative that the first e-mail message has been received
means for, after receiving the second e-mail message, assigning a second one of the status codes to the inquiry-response transaction to thereby indicate that the second e-mail message has been received.

21. The automated inquiry-response e-mail based content delivery system for delivering items of content from a repository to client devices at remote locations of claim 20, the method further comprising
means for, after responding with the prompt message, assigning a third one of the status codes to the inquiry-response transaction to thereby indicate that the prompt e-mail message has been sent
means for, after responding with the response e-mail message, assigning a fourth one of the status codes to the inquiry-response transaction to thereby indicate that the response e-mail message has been sent.

22. An automated inquiry-response e-mail based content delivery system for delivering items of content from a repository to client devices at remote locations, the automated inquiry-response e-mail based content delivery system comprising
a first database storing respective descriptions of the items of content
a second database storing respective order codes for the items of content
a server comprising a general purpose computer having machine readable computer programs for
receiving a first message via e-mail from a user of a given client device at a remote location, whereby an inquiry-response transaction is initiated
assigning a tracking code for the inquiry-response transaction
responding via e-mail to the first e-mail message with a prompt message, the prompt e-mail message including an arrangement of descriptions and order codes for a plurality of the items of content, the tracking code, and instructions to the user for ordering the items of content
receiving a second message via e-mail from the user
parsing the second e-mail message and identifying the tracking code in the second e-mail message
parsing the second e-mail message for at least one of the order codes specified by the user
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

23. The automated inquiry-response e-mail based content delivery system for delivering items of content from a repository to client devices at remote locations of claim 22, machine readable computer programs further for detecting if the second e-mail message has at least one order code specified by the user, and if not then responding via e-mail to the second e-mail message with a simpler prompt message, the simpler prompt e-mail message including the arrangement of descriptions and order codes for a plurality of the items of content, the tracking code, and simpler instructions to the user for ordering the items of content.

24. The automated inquiry-response e-mail based content delivery system for delivering items of content from a repository to client devices at remote locations of claim 23, the machine readable computer programs further for
receiving a third message via e-mail from the user
parsing the third e-mail message and identifying the tracking code in the third e-mail message
parsing the third e-mail message for at least one of the order codes specified by the user
detecting if the third e-mail message has at least one order code specified by the user, and if not then referring the third e-mail message to a human specialist at a client device
detecting if the third e-mail message has at least one order code specified by the user, and if so then
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

25. The automated inquiry-response e-mail based content delivery system for delivering items of content from a repository to client devices at remote locations of claim 22, wherein the response e-mail message includes the tracking code.

26. The automated inquiry-response e-mail based content delivery system for delivering items of content from a repository to client devices at remote locations of claim 22, the machine readable computer programs for receiving the first e-mail message further comprising machine readable computer programs for storing the first e-mail message.

27. The automated inquiry-response e-mail based content delivery system for delivering items of content from a repository to client devices at remote locations of claim 22, the machine readable computer programs for receiving the second e-mail message further comprising machine readable computer programs for storing the second e-mail message.

28. The automated inquiry-response e-mail based content delivery system for delivering items of content from a repository to client devices at remote locations through e-mail based inquiry-response automation of claim 22, wherein
the items of content comprise technical support documents
the descriptions of the items of content comprise common technical support questions which are answered by the respective technical support documents.

29. The automated inquiry-response e-mail based content delivery system for delivering items of content from a repository to client devices at remote locations of claim 22, the machine readable computer programs further for
after receiving the first e-mail message, assigning a first one of plural status codes signifying varying states of e-mail based inquiry-response transactions, the first status code to indicative that the first e-mail message has been received
after receiving the second e-mail message, assigning a second one of the status codes to the inquiry-response transaction to thereby indicate that the second e-mail message has been received.

30. The automated inquiry-response e-mail based content delivery system for delivering items of content from a repository to client devices at remote locations of claim 22, the machine readable computer programs further for
after responding with the prompt message, assigning a third one of the status codes to the inquiry-response transaction to thereby indicate that the prompt e-mail message has been sent
after responding with the response e-mail message, assigning a fourth one of the status codes to the inquiry-response transaction to thereby indicate that the response e-mail message has been sent.

31. A method of delivering items of content to client devices at remote locations through e-mail based inquiry-response automation, wherein the items of content are stored in a repository, and there are also stored respective descriptions of the items of content and respective order codes for the items of content, the method comprising the steps of
receiving a first message via e-mail from a user of a given client device at a remote location, whereby an inquiry-response transaction is initiated
assigning a tracking code for the inquiry-response transaction
responding via e-mail to the first e-mail message with a prompt message, the prompt e-mail message including an arrangement of descriptions and order codes for a plurality of the items of content, the tracking code, and instructions to the user for ordering the items of content
receiving a second message via e-mail from the user
parsing the second e-mail message and identifying the tracking code in the second e-mail message
parsing the second e-mail message for at least one of the order codes specified by the user
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

32. The method of delivering items of content from a storage location to client devices at remote locations through e-mail based inquiry-response automation of claim 31, further comprising, after the step of parsing the second e-mail message for at least one of the order codes, if the second e-mail message does not have at least one order code specified by the user, then responding via e-mail to the second e-mail message with a simpler prompt message, the simpler prompt e-mail message including the arrangement of descriptions and order codes for a plurality of the items of content, the tracking code, and simpler instructions to the user for ordering the items of content.

33. The method of delivering items of content from a storage location to client devices at remote locations through e-mail based inquiry-response automation of claim 31, further comprising
receiving a third message via e-mail from the user
parsing the third e-mail message and identifying the tracking code in the third e-mail message
parsing the third e-mail message for at least one of the order codes specified by the user
if the third e-mail message does not have at least one order code specified by the user, then referring the third e-mail message to a human specialist at a client device
if the third e-mail message has at least one order code specified by the user, then
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.

34. The method of delivering items of content from a storage location to client devices at remote locations through e-mail based inquiry-response automation of claim 31, wherein the response e-mail message includes the tracking code.

35. The method of delivering items of content from a storage location to client devices at remote locations through e-mail based inquiry-response automation of claim 31, the step of receiving the first e-mail message further comprising storing the first e-mail message.

36. The method of delivering items of content from a storage location to client devices at remote locations through e-mail based inquiry-response automation of claim 31, the step of receiving the second e-mail message further comprising storing the second e-mail message.

37. The method of delivering items of content from a storage location to client devices at remote locations through e-mail based inquiry-response automation of claim 31, wherein
the items of content comprise technical support documents
the descriptions of the items of content comprise common technical support questions which are answered by the respective technical support documents.

38. The method of delivering items of content from a storage location to client devices at remote locations through e-mail based inquiry-response automation of claim 31, the method further comprising
after receiving the first e-mail message, assigning a first one of plural status codes signifying varying states of e-mail based inquiry-response transactions, the first status code to indicative that the first e-mail message has been received
after receiving the second e-mail message, assigning a second one of the status codes to the inquiry-response transaction to thereby indicate that the second e-mail message has been received.

39. The method of delivering items of content from a storage location to client devices at remote locations through e-mail based inquiry-response automation of claim 38, the method further comprising
after responding with the prompt message, assigning a third one of the status codes to the inquiry-response transaction to thereby indicate that the prompt e-mail message has been sent
after responding with the response e-mail message, assigning a fourth one of the status codes to the inquiry-response transaction to thereby indicate that the response e-mail message has been sent.

40. An automated inquiry-response e-mail based content delivery system for delivering items of content to client devices at remote locations, the content delivery system comprising
memory means for storing a multiplicity of machine-readable documents
e-mail receipt processing means for receiving e-mail messages from the client devices and determining if the e-mail messages include tracking codes
prompting means, coupled to the e-mail receipt processing means, for responding to those e-mail messages from the client devices which do not include tracking codes, the prompting means including means for assigning tracking codes and means for sending prompt messages via e-mail to the client devices having the tracking codes to prompt the users to specify order codes denoting one or more selected documents
e-mail message delivery means, coupled to the e-mail receipt processing means and the memory means, for automatically collecting the selected documents into a single package unit and delivering e-mail messages containing the single packet units to the users via e-mail.

41. A method of delivering items of content to client devices at remote locations through e-mail based inquiry-response automation, wherein the items of content are stored in a repository, and there are also stored respective descriptions of the items of content and respective order codes for the items of content, the method comprising the steps of
receiving a first message via e-mail from a user of a given client device at a remote location, whereby an inquiry-response transaction is initiated
responding via e-mail to the first e-mail message with a prompt message, the prompt e-mail message including an arrangement of descriptions and order codes for a plurality of the items of content, and instructions to the user for ordering the items of content
receiving a second message via e-mail from the user
parsing the second e-mail message and determining that the second e-mail message is part of the same transaction as the first e-mail message and the prompt e-mail message
parsing the second e-mail message for at least one of the order codes specified by the user
extracting the items of content identified by the order codes in the second e-mail message
packaging the items of content from the extracting step into a single package unit
responding via e-mail to the second e-mail message with a response e-mail message comprising the single package unit comprising the items of content corresponding to the order codes in the second e-mail message.
